(19) United States
(12) Patent Application Publication
(10) Pub. No.: US 2017/0026561 A1
(43) Pub. Date: Jan. 26, 2017

(54) SYSTEM AND METHOD FOR ADJUSTING BRIGHTNESS OF LIGHT SOURCE OF CRITICAL DIMENSION MEASURING DEVICE

(71) Applicants: BOE TECHNOLOGY GROUP CO., LTD., Beijing (CN); HEFEI BOE OPTOELECTRONICS TECHNOLOGY CO., LTD., Hefei, Anhui (CN)

(72) Inventors: Dezhi Xu, Beijing (CN); Cheng Chen, Beijing (CN); Lei Wang, Beijing (CN)

(21) Appl. No.: 15/123,920

(22) PCT Filed: Aug. 12, 2015
(86) PCT No.: PCT/CN2015/086744

§ 371 Date: Sep. 6, 2016

(30) Foreign Application Priority Data
Mar. 13, 2015 (CN) 201510112933.4

(51) Int. Cl. H04N 5/235; G06T 7/00

(52) U.S. Cl. CPC H04N 5/2354; G06T 7/0006; H04N 5/2351; G06T 2207/30148; G06T 2207/30208; H05B 41/38

(57) ABSTRACT

The present disclosure provides a system and a method for adjusting brightness of a light source of a critical dimension measuring device. The system for adjusting brightness of the light source comprises: a calibration mark unit which is formed on a display panel by photolithography and is provided with a plurality of marks; a mark pattern acquiring unit which is configured to acquire patterns of the plurality of marks; a mark data collecting unit which is configured to obtain actual line widths and actual line spaces of the plurality of marks based on the patterns of the plurality of marks, and to calculate a ratio of a sum of an average value of the actual line width and an average value of the actual line space to a sum of a predefined line width and a predefined line space; a mark data determining unit which is configured to determine whether the ratio is within a predefined range; and a unit for automatically adjusting brightness of light source which is configured to generate a brightness adjusting signal of the light source to adjust a driving voltage of the light source if the mark data determining unit determines that the ratio is outside of the predefined range. The accuracy of the critical dimension measuring is improved by properly adjusting the brightness of the light source.

### CROSS-REFERENCE TO RELATED APPLICATION(S)

This application claims priority to Chinese Application No. 201510112933.4, filed on Mar. 13, 2015 and entitled “SYSTEM AND METHOD FOR ADJUSTING BRIGHTNESS OF LIGHT SOURCE OF CRITICAL DIMENSION MEASURING DEVICE,” which is incorporated herein by reference in their entirety.

### TECHNICAL FIELD

The present disclosure relates to display field, and particularly to system and method for adjusting brightness of light source of critical dimension measuring device.

### BACKGROUND

During a process of manufacturing a liquid crystal display panel, a critical dimension (CD) measurement is a measuring method for detecting whether photolithography (DI critical dimension) and etching (FI critical dimension) meet designing requirements. Critical dimension measuring device is an important device for monitoring critical line width and a size of line space during the process of manufacturing a semiconductor and liquid crystal display panel array. Thus, accuracy and precision of the critical dimension measuring device play an importance role for producing semiconductor and thin film transistor (TFT) devices which meet the designing requirement. The critical dimension measuring device is mainly constituted of a measuring base station, an optical microscope system, an illumination system and so on. The illumination system primarily utilizes a halogen lamp. A lighting unit in the illumination system generally needs to be replaced after a service time of about 2000 hours in order to guarantee measuring brightness and measuring accuracy. Even it is replaced with a new lighting unit, during using of the new lighting unit, the measuring precision and stability will change with brightness attenuation of the lighting unit, which leads to it is impossible to normally monitor the critical dimension.

### SUMMARY

The present disclosure provides a system for adjusting brightness of a light source of a critical dimension measuring device and a method for adjusting brightness of a light source of a critical dimension measuring device, so as to solve issues of deviation and instability of the measuring data which are caused by attenuation of the light source of the critical dimension measuring device over time.

An aspect of the present disclosure provides a system for adjusting brightness of a light source of a critical dimension measuring device, which comprises: a calibration mark unit which is formed on a display panel by photolithography and is provided with a plurality of marks; a mark pattern acquiring unit which is configured to acquire patterns of the plurality of marks; a mark data collecting unit which is configured to obtain actual line widths and actual line spaces of the plurality of marks based on the patterns of the plurality of marks, and to calculate a ratio of a sum of an average value of the actual line width and an average value of the actual line space to a sum of a predefined line width and a predefined line space; a mark data determining unit which is configured to determine whether the ratio is within a predefined range; and a unit for automatically adjusting brightness of light source which is configured to generate a brightness adjusting signal of the light source to adjust a driving voltage of the light source if the mark data determining unit determines that the ratio is outside of the predefined range.

Another aspect of the present disclosure provides a method for adjusting brightness of a light source of a critical dimension measuring device, which comprises steps of: forming a calibration mark unit provided with a plurality of marks on a display panel by photolithography; acquiring patterns of the plurality of marks; obtaining actual line widths and actual line spaces of the plurality of marks based on the patterns of the plurality of marks, and calculating a ratio of a sum of an average value of the actual line width and an average value of the actual line space to a sum of a predefined line width and a predefined line space; determining whether the ratio is within a predefined range; and generating a brightness adjusting signal of the light source to adjust a driving voltage of the light source if it is determined that the ratio is outside of the predefined range.

Preferably, the pluralities of marks are provided as grid patterns with a line width/line space in a horizontal direction, in an inclining direction of 45 degree or in a vertical direction.

Preferably, the calibration mark unit is formed at one corner of each of thin transistor layers in the display panel.

Preferably, the brightness of the light source is adjusted after a predefined period since the brightness of the light source is constant.

Preferably, the predefined range is 1.0±0.1.

Preferably, the values of predefined line width and the predefine line space are identical to each other and are within a range of 3.5 μm and 10 μm.

The system and method for adjusting brightness of a light source of a critical dimension measuring device properly adjust the brightness of the light source by determining whether the ratio of a sum of an average value of the actual line width and an average value of the actual line space for the plurality of marks provided in the calibration mark unit to a sum of a predefined line width and a predefined line space is within the predefined range to determine whether the brightness of the light source is proper, which enhance accuracy of the critical dimension measuring.

### BRIEF DESCRIPTION OF THE DRAWINGS

The above and other aspects, features and advantages of the plurality of embodiments of the present disclosure will be more apparent according to the following detailed description in conjunction with the accompany figures, in which:

FIG. 1 is a schematic view of a configuration of the system for adjusting brightness of a light source of the critical dimension measuring device according to an embodiment of the present disclosure;

FIG. 2 is a schematic view of a calibration mark unit provided in the display panel according to an embodiment of the present disclosure;

FIGS. 3A-3D is a schematic view of marks provided in the calibration mark unit according to an embodiment of the present disclosure; and

FIG. 4 is a flowchart of the method for adjusting brightness of a light source of the critical dimension measuring device according to an embodiment of the present disclosure.

### DETAILED DESCRIPTION

The embodiments of the present disclosure provide a system and a method for adjusting brightness of a light source of a critical dimension measuring device. By adjusting the brightness of the light source for measurement, the sum of the line width and the line space of the mark provided in the calibration mark unit is within the range of specification for the mark. Thus, the issues of deviation and instability of the measuring data which are caused by attenuation of the light source of the critical dimension measuring device over times may be avoided.

Particular implementations of the present invention will be illustrated in detail by referring to the accompany figures and the particular embodiments.

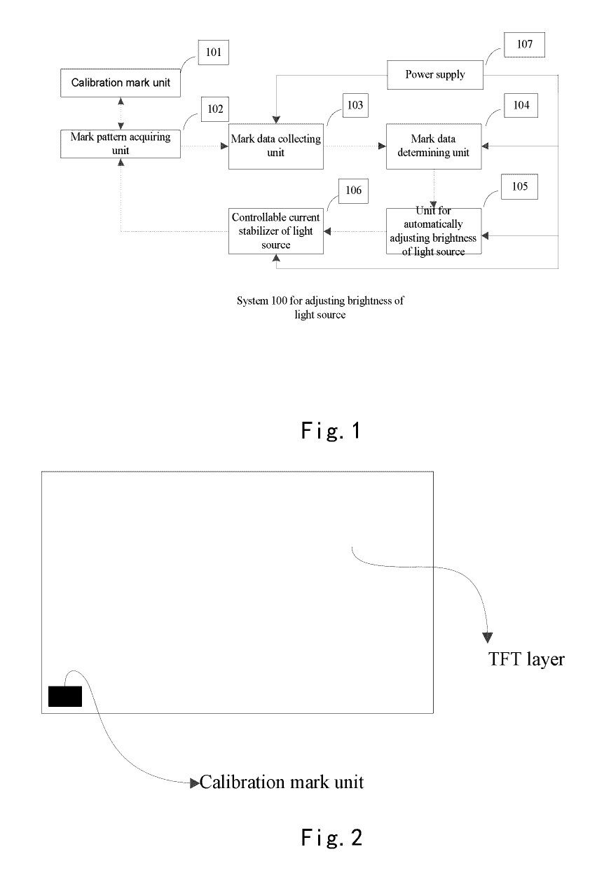

By referring to FIG. 1, FIG. 1 is a schematic view of a configuration of the system 100 for adjusting brightness of a light source of the critical dimension measuring device according to an embodiment of the present disclosure. The system 100 for adjusting brightness of the light source comprises a calibration mark unit 101, a mark pattern acquiring unit 102, a mark data collecting unit 103, a mark data determining unit 104, and a unit 105 for automatically adjusting brightness of light source, a controllable current stabilizer 106 (optional) of the light source and a power supply 107.

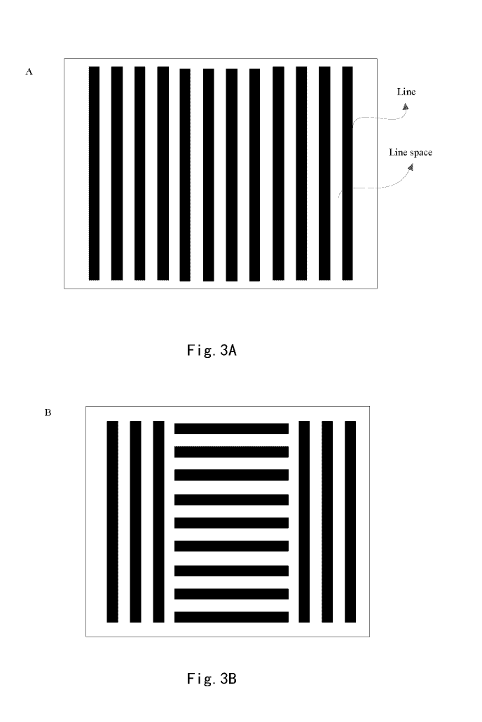

The calibration mark unit 101 is formed on the display panel by photolithography. As shown in FIG. 2, the calibration mark unit 101 is formed at a bottom left corner of each of a glass layer of the thin transistor (TFT) in the display panel. However, the position of the calibration mark unit 101 in the glass layer of the TFT is not limited to the bottom left corner, and it may also be a top left corner, a top right corner, a bottom right corner and so on. A purpose of providing the calibration mark unit 101 at any corner of the glass layer o TFT is to prevent measuring of the critical dimension of the display panel from being influenced by the calibration mark unit.

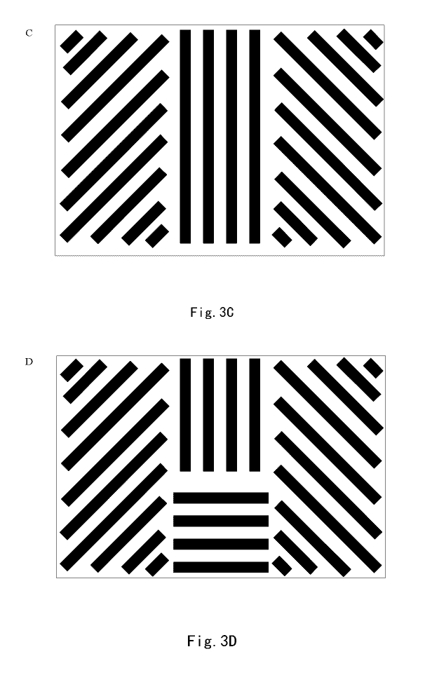

Pluralities of marks are provided in the calibration mark unit 10. FIGS. 3A-3D show schematic views of four different types of configuration of the marks in the calibration mark unit 101. Herein, the mark may be strips with identical line widths and lines spaces of these stripes are also identical to each other. However, lengths and directions of the marks may be different from each other. The marks in FIG. 3A are designed to be grid patterns with identical line widths/line spaces in the horizontal direction; the marks in FIG. 3B are designed to be grid patterns with identical line widths/line spaces in the horizontal direction and the vertical direction; the marks in FIG. 3C are designed to be grid patterns with identical line widths/line spaces in an inclining direction of 45 degree and in the vertical direction; and the marks in FIG. 3C are designed to be grid patterns with identical line widths/line spaces in the horizontal direction, in the inclining direction of 45 degree and in the vertical direction. Different calibration patterns may be designed to be fit for different critical dimension measuring.

The mark pattern acquiring unit 102 is connected to the calibration mark unit 101, and is configured to acquire patterns of the plurality of marks in the calibration mark unit 101. Preferably, the mark pattern acquiring unit 102 may be an optical microscope. In particular, the mark pattern acquiring unit 102 emits a laser light to the calibration mark unit 101, and continuously focuses a focusing component by a driving mechanism (not shown). During such a process, the lens rapidly captures images of the calibration mark unit 101 (e.g. 60 frames per second); and then the most clear image is found from the captured images to successfully accomplish the focusing. The mark pattern acquiring unit 102 transmits the patterns of the plurality of captured marks (i.e. the most clear captured image) to the mark data collection unit 103. A connection between the mark pattern acquiring unit 102 and the calibration mark unit 101 may be an actual physical connection, and may be space coupling or optical coupling, as long as the mark pattern acquiring unit 106 may acquire patterns of the marks of the calibration mark unit 101.

The mark data collecting unit 103 obtains actual line widths (W1) and actual line spaces (S1) of the plurality of marks based on the patterns of the plurality of marks which are obtained at a specific brightness, and calculates a ratio D1 of a sum (W1+S1) of an average value of the actual line width (W1) and an average value of the actual line space (S1) to a sum (W0+S0) of a predefined line width (W0) and a predefined line space (S0): D1=(W1+S1)/(W0+S0). The mark data collection unit 103 transmits the calculated ratio D1 to the mark data determining unit 101. Preferably, in consideration of resolution limitation of an exposure machine, the values of the predefined line width (W0) and the predefined line space (S) are identical to each other and may be 3.5 μm or above. However, the values of the line width and the line space should not be too large (e.g. not exceeding 10 μm) so as to avoid limiting space for providing the calibration mark unit 101 in the display panel.

The mark data determining unit 104 determines whether the ratio D1 received from the mark data collecting unit 103 is within the predefined range. Preferably, the predefined range is 1.0±0.1. if the ratio D1 is within the predefined range, the mark data determining unit 104 determines that the brightness of light source for measuring is an appropriate brightness; otherwise, the mark data determining unit 104 determines that the brightness of light source for measuring is not an appropriate brightness. Then, the mark data determining unit 104 transmits a determination result to the unit 105 for automatically adjusting brightness of light source.

The unit 105 for automatically adjusting brightness of light source is configured to generate the brightness adjusting signal of the light source to adjust a driving voltage of the light source or to supply the signal to the controllable current stabilizer 106 of the light source based on the determination result (i.e. if the mark data determining unit determines that the ratio D1 is outside of the predefined range).

The controllable current stabilizer 106 of the light source adjusts the driving voltage supplied to the light source of the mark pattern acquiring unit 102 based on the brightness adjusting signal of the light source, so that the mark pattern acquiring unit 102 operates in the adjusted brightness of the light source. In particular, if the ratio D1 is larger than 1.0+0.1, the brightness of the light source may be decreased, which may be carried out by decreasing a voltage for driving the light source. That is to say, the voltage for driving the light source is deceased by 0.1V every time until the brightness meets the requirement (i.e. the ratio D1 is within the predefined range). On the contrary, if D1 is smaller than 1.0-0.1, the voltage for driving the light source is increased by 0.1V every time until the brightness meets the requirement.

The unit 105 for automatically adjusting brightness of light source may incorporate the function of the controllable current stabilizer 106 of the light source. For example, the unit 105 for automatically adjusting brightness of light source is configured to generate a brightness adjusting signal of the light source to adjust the voltage for driving the light source supplied to the mark pattern acquiring unit 102 based on the determination result (i.e. if the mark data determining unit determines that the ratio D1 is outside of the predefined range), so that the mark pattern acquiring unit 102 operates in the adjusted brightness of the light source. In particular, if the ratio D1 is larger than 1.0+0.1, the brightness of the light source may be decreased, which may be carried out by decreasing the voltage for driving the light source. That is to say, the voltage for driving the light source is deceased by 0.1V every time until the brightness meets the requirement (i.e. the ratio D1 is within the predefined range). On the contrary, if D1 is smaller than 1.0-0.1, the voltage for driving the light source is increased, i.e. increased by 0.1V every time until the brightness meets the requirement.

Preferably, the system for adjusting the brightness of the light source may adjust the brightness of the light source after a predefined period since the brightness of the light source is constant, the reason for which is the brightness of the light source attenuates the most distinctly during the predefined period. Preferably, the predefined period may be one month.

The system 100 for adjusting brightness of the light source according to the embodiment of the present disclosure measures and determines whether the ratio of the sum (W1+S1) of an average value of the actual line width and an average value of the actual line space for the plurality of marks provided in the calibration mark unit 101 to the sum (W0+S0) of the predefined line width and the predefined line space is within the predefined range to determine whether the brightness of the light source is proper, and appropriately adjust the brightness of the light source, which enhance accuracy of the critical dimension measuring.

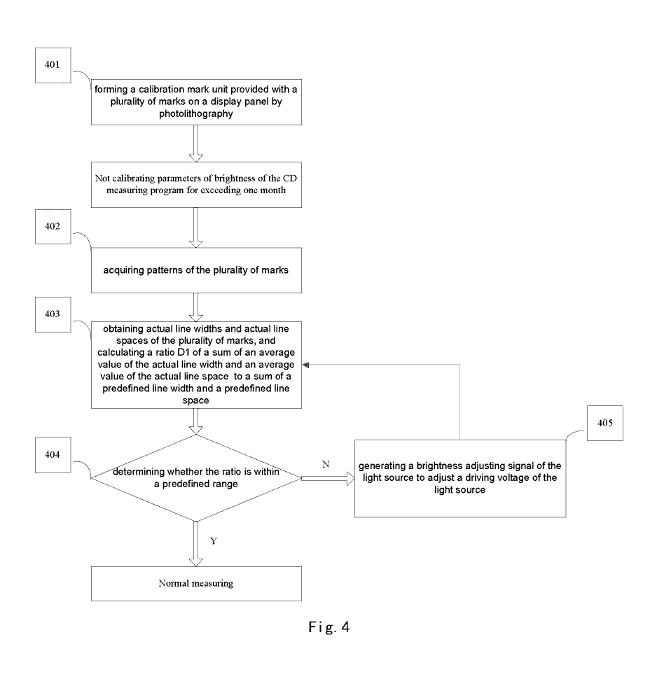

The flowchart of the method for adjusting brightness of a light source of the critical dimension measuring device will be illustrated in detail by referring to FIG. 4.

At a step of 401, a calibration mark unit is formed on a display panel by photolithography and the calibration mark unit is provided with a plurality of marks.

At a step of 402, patterns of the plurality of marks are acquired. Preferably, the step of 402 is implemented when it is determined that the method for adjusting brightness of a light source of the critical dimension measuring device is not implemented after one month since the brightness of the light source is constant, so as to keep away from a period during which the brightness of the light source is attenuated distinctly.

At a step of 403, actual line widths and actual line spaces of the plurality of marks are obtained based on the patterns of the plurality of marks, and a ratio D1 of a sum of an average value of the actual line width and an average value of the actual line space to a sum of a predefined line width and a predefined line space is calculated.

At a step of 404, it is determined whether the ratio is within a predefined range. Preferably, the predefined range may be 1.0±0.1.

If the ratio D1 is within the predefined range, a normal measurement is implemented; otherwise, at a step of 405, a brightness adjusting signal of the light source is generated to adjust the brightness of the light source.

The method for adjusting brightness of the light source according to the embodiment may adjust the brightness of the light source so as to decrease data deviation of critical dimension measuring and to improve measuring precision.

It is apparent that those skilled in the art may make any changes and modifications on the embodiments of the present invention without departing from the spirit and scope of the present invention. The scope of the present invention is defined by the accompany claims and their equivalents.

I claim:

1. A system for adjusting brightness of a light source of a critical dimension measuring device, which comprises:
a calibration mark unit which is formed on a display panel by photolithography and is provided with a plurality of marks;
a mark pattern acquiring unit which is configured to acquire patterns of the plurality of marks;
a mark data collecting unit which is configured to obtain actual line widths and actual line spaces of the plurality of marks based on the patterns of the plurality of marks, and to calculate a ratio of a sum of an average value of the actual line width and an average value of the actual line space to a sum of a predefined line width and a predefined line space;
a mark data determining unit which is configured to determine whether the ratio is within a predefined range; and
a unit for automatically adjusting brightness of light source which is configured to generate a brightness adjusting signal of the light source to adjust a driving voltage of the light source if the mark data determining unit determines that the ratio is outside of the predefined range.

2. The system for adjusting brightness of a light source of a critical dimension measuring device according to claim 1, wherein the plurality of marks are provided as grid patterns with a line width/line space in a horizontal direction, in an inclining direction of 45 degree or in a vertical direction.

3. The system for adjusting brightness of a light source of a critical dimension measuring device according to claim 1, wherein the calibration mark unit is formed at one corner of each of thin transistor layers in the display panel.

4. The system for adjusting brightness of a light source of a critical dimension measuring device according to claim 1, wherein the brightness of the light source is adjusted after a predefined period since the brightness of the light source is constant.

5. The system for adjusting brightness of a light source of a critical dimension measuring device according to claim 1, wherein the predefined range is 1.0±0.1.

6. The system for adjusting brightness of a light source of a critical dimension measuring device according to claim 1, wherein the values of predefined line width and the predefine line space are identical to each other and are within a range of 3.5 μm and 10 μm.

7. The system for adjusting brightness of a light source of a critical dimension measuring device according to claim 1, further comprising controllable current stabilizer of the light source which is configured to adjust the driving voltage of the light source based on the brightness adjusting signal of the light source.

8. A method for adjusting brightness of a light source of a critical dimension measuring device, which comprises steps of:
forming a calibration mark unit provided with a plurality of marks on a display panel by photolithography;
acquiring patterns of the plurality of marks;
obtaining actual line widths and actual line spaces of the plurality of marks based on the patterns of the plurality of marks, and calculating a ratio of a sum of an average value of the actual line width and an average value of the actual line space to a sum of a predefined line width and a predefined line space;
determining whether the ratio is within a predefined range; and
generating a brightness adjusting signal of the light source to adjust a driving voltage of the light source if it is determined that the ratio is outside of the predefined range.

9. The method for adjusting brightness of a light source according to claim 8, wherein the plurality of marks are provided as grid patterns with a line width/line space in a horizontal direction, in an inclining direction of 45 degree or in a vertical direction.

10. The method for adjusting brightness of a light source according to claim 8, wherein the calibration mark unit is formed at one corner of each of thin transistor layers in the display panel.

11. The method for adjusting brightness of a light source according to claim 8, wherein the brightness of the light source is adjusted after a predefined period since the brightness of the light source is constant.

12. The method for adjusting brightness of a light source according to claim 8, wherein the predefined range is 1.0±0.1.

13. The method for adjusting brightness of a light source according to claim 8, wherein the values of predefined line width and the predefine line space are identical to each other and are within a range of 3.5 μm and 10 μm.
